(19) United States
(12) Patent Application Publication
(10) Pub. No.: US 2021/0114430 A1
(43) Pub. Date: Apr. 22, 2021

(54) TRAVELING BODY

(71) Applicant: TOYOTA JIDOSHA KABUSHIKI KAISHA, Aichi-ken (JP)

(72) Inventors: Zixun MEI, Tokyo (JP); Hiroyuki KOBAYASHI, Tokyo (JP); Takashi NISHIMURA, Tokyo (JP); Takuya WATABE, Tokyo (JP)

(21) Appl. No.: 16/993,259

(22) Filed: Aug. 14, 2020

(30) Foreign Application Priority Data
Oct. 16, 2019 (JP) 2019-189127

(51) Int. Cl. B60G 21/00; B62D 61/10; B60K 1/02; B62D 57/036

(52) U.S. Cl. CPC B60G 21/007; B62D 57/036; B60K 1/02; B62D 61/10

(57) ABSTRACT

A traveling body is equipped with a traveling portion provided on a lower side of a main body portion. The traveling portion has middle wheels that are spaced apart from a rising axis extending in a width direction by a fixed distance, front links that space front wheels and the rising axis apart from each other respectively by a fixed distance, rear links that space rear wheels and the rising axis apart from each other respectively by a fixed distance, and a fixed frame that rises/falls as the rising axis rises/falls and that supports the main body portion. The front links and the rear links are coupled in such a manner as to be able to rock with respect to each other respectively around the rising axis. A controller lifts the main body portion and the middle wheels by rocking the front links and the rear links each other.

### INCORPORATION BY REFERENCE

The disclosure of Japanese Patent Application No. 2019-189127 filed on Oct. 16, 2019 including the specification, drawings and abstract is incorporated herein by reference in its entirety.

### BACKGROUND

### 1. Technical Field

The present specification discloses a traveling body that is equipped with a main body portion and a traveling portion provided on a lower side of the main body portion, with the traveling portion having a total of six wheels consisting of a front-right wheel, a middle-right wheel, and a rear-right wheel arranged in a longitudinal direction, and a front-left wheel, a middle-left wheel, and a rear-left wheel arranged in the longitudinal direction.

### 2. Description of Related Art

Conventionally, there is known a traveling body that is equipped with a traveling portion, and a main body portion provided on the traveling portion. For example, Japanese Patent Application Publication No. 2017-222297 (JP 2017-222297 A) discloses a traveling device that is equipped with a main body (corresponding to the main body portion) and a wagon (corresponding to the traveling portion). In Japanese Patent Application Publication No. 2017-222297 (JP 2017-222297 A), the wagon is provided with a rocker bogie mechanism. As shown in FIG. 13, the rocker bogie mechanism is a mechanism having six wheels, namely, three right wheels and three left wheels arranged. In this mechanism, front wheels 20 and middle wheels 22 are coupled to each other by bogie links 102 respectively, and the bogie links 102 and rear wheels 24 are coupled to each other by rocker links 100 respectively. This rocker bogie mechanism allows the traveling body to travel over a bump or on a slope while the respective wheels stay in contact with a road surface. As a result, the rocker bogie mechanism allows the traveling body to stably travel on a bumpy surface or an irregular surface as well, and high ability to overcome obstacles while traveling is obtained.

### SUMMARY

In this case, it may be desirable to make the height of arrangement of the main body portion provided on the traveling portion variable depending on the circumstances. For example, it is desirable to provide the main body portion at a low position to lower the center of gravity of the traveling body when the traveling body travels. However, it is desirable to raise the main body portion to a high position that makes the main body portion easily accessible by people, when the traveling body stops and those people access the main body portion. However, in Japanese Patent Application Publication No. 2017-222297 (JP 2017-222297 A), no consideration is given to a mechanism for changing the height of the main body portion in such a manner.

As a matter of course, it is conceivable to provide an elevating mechanism between the traveling portion and the main body portion and elevate and lower the main body portion independently of the traveling portion. However, in the case where this elevating mechanism is provided, the traveling body is more complicated in structure and more expensive. Besides, the motion of raising only the main body portion independently of the motion of the traveling portion is greatly different from the motion of a quadrupedal animal such as a dog or a cat, so people are unlikely to feel an affinity with the traveling body.

Thus, the present specification discloses a traveling body which has high ability to overcome obstacles while traveling, which has a main body portion that can be changed in height, and with which people tend to feel an affinity.

A traveling body disclosed in the present specification is equipped with a main body portion, and a traveling portion provided on a lower side of the main body portion. The traveling portion has a pair of middle wheels, namely, a middle-right wheel and a middle-left wheel that are spaced apart from a rising axis extending in a width direction by a fixed distance, a pair of front wheels that are arranged in front of the middle wheels respectively, a pair of rear wheels that are arranged behind the middle wheels respectively, front links that space the front wheels and the rising axis apart from each other respectively by a fixed distance, rear links that space the rear wheels and the rising axis apart from each other respectively by a fixed distance, a fixed frame that rises/falls as the rising axis rises/falls, and that supports the main body portion, and a controller. The front links and the rear links are coupled in such a manner as to be able to rock with respect to each other respectively around the rising axis, and the controller lifts the main body portion and the middle wheels by rocking the front links and the rear links with respect to each other respectively.

By providing the front wheels, the middle wheels, and the rear wheels that are coupled to each other by the links respectively, the traveling body can stably travel over a bump or on a slope as well, so high ability to overcome obstacles while traveling is obtained. Besides, the motion of lifting the main body portion by rocking the front links and the rear links is closer to the motion of a quadrupedal animal such as a dog or a cat that straightens up than in the case where the main body portion is raised independently of the traveling portion. As a result, people tend to feel an affinity with the traveling body.

Besides, the traveling portion may further have a rising motor, and a transmission mechanism that transmits a motive power output by the rising motor to the front links or the rear links, as a rocking motion around the rising axis, without the intermediary of the wheels.

By providing a dedicated motor for the rising motion, the control of rotating the wheels and the motion of lifting the middle wheels and the main body portion can be controlled independently of each other. Therefore, the control of the traveling body can be simplified.

In this case, the traveling portion may further have front-wheel motors that rotate the front wheels respectively, and rear-wheel motors that rotate the rear wheels respectively, and the rising motor, the front-wheel motors, and the rear-wheel motors can be driven independently of one another.

By adopting this configuration, the control of rotating the front wheels, the control of rotating the rear wheels, and the control of lifting the middle wheels and the main body portion can all be performed independently of one another, and the control of driving the traveling body can be simplified.

Besides, the traveling portion may further have a vertical swing motor that rocks the main body portion around the rising axis.

By rocking the main body portion around the rising axis through the use of the vertical swing motor, the inclination of the main body portion resulting from the lifting of the main body portion can be corrected. Besides, by rocking the main body portion around the rising axis, the main body portion can be kept horizontal even when the traveling body travels on a slope. Furthermore, by rocking the main body portion around the rising axis, the main body portion can be caused to make a motion close to “bowing” or “nodding”.

Besides, the traveling portion may further have a lateral swing motor that rotates the main body portion around a lateral swing axis extending in a height direction of the main body portion.

By rotating the main body portion around the lateral swing axis through the use of the lateral swing motor, the direction of the main body portion can be changed depending on the circumstances. Besides, by making the main body portion rotatable around the lateral swing axis, the main body portion can be caused to make a motion close to “shaking one's head”.

Besides, each of the front wheels and the rear wheels may be a Mecanum wheel having a barrel-shaped roller arranged on a circumferential surface of the wheel, and the controller may move the traveling body in all directions by rotationally driving the front wheels and the rear wheels, with the middle wheels lifted.

By adopting this configuration, the traveling body can move in all directions. Therefore, the mobility of the traveling body is improved.

Besides, the traveling portion may further have front link covers that cover the front links respectively, rear link covers that cover the rear links respectively, and antiskid members that are provided on at least either front end surfaces of the front link covers or rear end surfaces of the rear link covers respectively.

The front end surfaces of the front link covers and the rear end surfaces of the rear link covers are regions that are in contact with the ground when the front links are inclined upward in the backward direction and the rear links are inclined upward in the forward direction to raise the main body portion high. By providing the antiskid members in those regions, the traveling body is unlikely to move relatively to the ground when the main body portion is lifted.

The traveling body disclosed in the present specification has high ability to overcome obstacles while traveling. Also, the height of the main body portion of the traveling body can be changed, and people tend to feel an affinity with the traveling body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a traveling body;

FIG. 2 is a perspective view of the traveling body with a main body portion thereof lifted;

FIG. 3 is a block diagram showing the electric configuration of the traveling body;

FIG. 4A is a schematic view of the traveling body as viewed sideways;

FIG. 4B is a schematic view of the traveling body at the time of traveling, as viewed sideways;

FIG. 5 is a schematic view of the traveling body at the time of handover of an article, as viewed sideways;

FIG. 6A is a schematic view of the traveling body at the time of traveling on a slope, as viewed sideways;

FIG. 6B is a schematic view of the traveling body at the time of traveling over a bump, as viewed sideways;

FIG. 7A is a schematic view of the laterally moving traveling body as viewed from above;

FIG. 7B is a schematic view of the turning traveling body as viewed from above;

FIG. 7C is a schematic view of the diagonally moving traveling body as viewed from above;

FIG. 8 is a partially exploded perspective view of the traveling body with covers thereof removed, as viewed from diagonally in front;

FIG. 9 is a partially exploded perspective view of the traveling body with the covers thereof removed, as viewed from diagonally behind;

FIG. 10 is a longitudinal cross-sectional view around a center shaft;

FIG. 11 is a longitudinal cross-sectional view around a coupling shaft;

FIG. 12 is a schematic view of the traveling body disclosed in the present specification; and

FIG. 13 is a schematic view of a traveling body mounted with a rocker bogie mechanism.

### DETAILED DESCRIPTION OF EMBODIMENTS

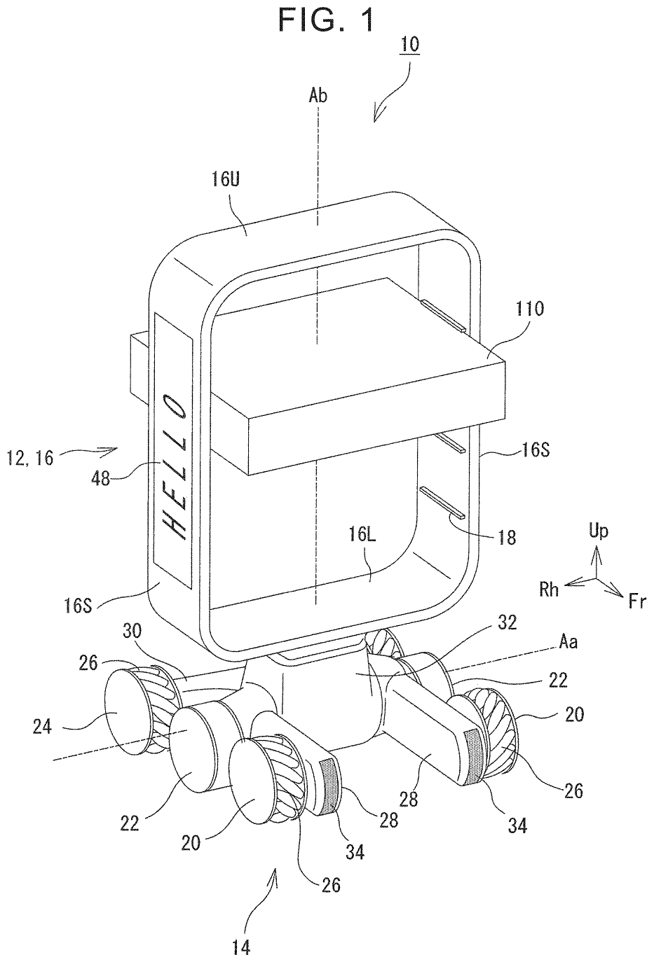

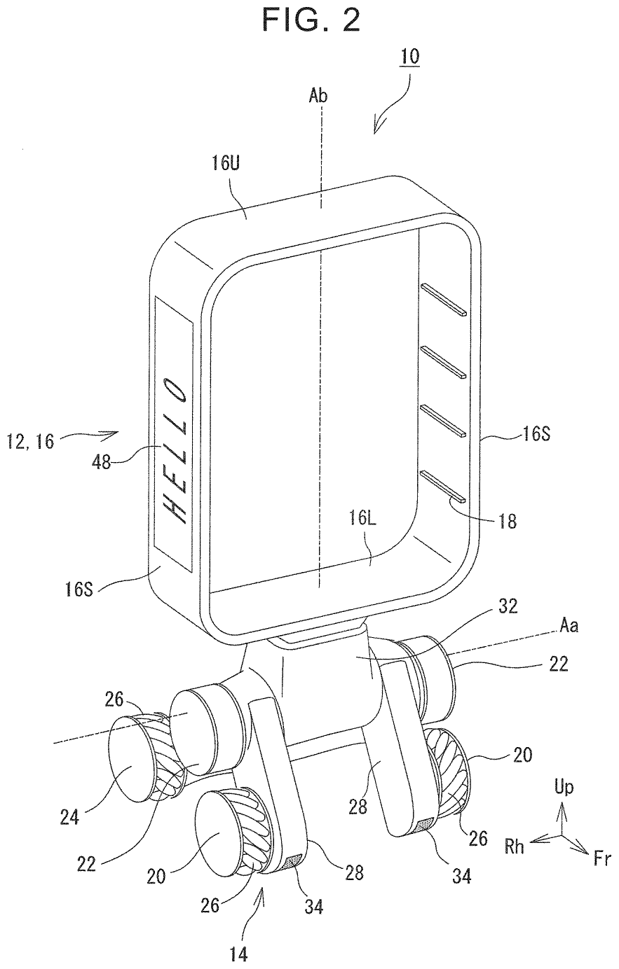

The configuration of a traveling body 10 will be described hereinafter with reference to the drawings. FIGS. 1 and 2 are perspective views of the traveling body 10. The intended purpose of the traveling body 10 is not limited in particular, but the traveling body 10 that is used as an article conveyance robot for conveying articles to destinations will be described hereinafter as an example. Incidentally, in the following description, “the longitudinal direction”, “the width direction”, and “the height direction” mean the longitudinal direction, the width direction, and the height direction of the traveling body 10 respectively, unless otherwise specified. Besides, the longitudinal direction of the traveling body 10 is a direction in which front wheels 20 and rear wheels 24 are aligned with each other respectively, the width direction of the traveling body 10 is a direction in which the front-right wheel 20 and the front-left wheel 20 are aligned with each other, and the height direction of the traveling body 10 is a direction perpendicular to the longitudinal direction and the width direction. Furthermore, in each of the following drawings, “Fr”, “Up”, and “Rh” indicate a forward direction, an upward direction, and a rightward direction with respect to the traveling body 10.

The traveling body 10 is broadly classified into a traveling portion 14 having a plurality of wheels, and a main body portion 12 provided on an upper side of the traveling portion 14. In the present example, the main body portion 12 functions as a holding portion that holds an article to be conveyed. The main body portion 12 has a rectangular ring-shaped ring body 16. The ring body 16 has a pair of side members 16S that extend in the height direction, an upper lateral member 16U that couples upper ends of the side members 16S to each other, and a lower lateral member 16L that couples lower ends of the side members 16S to each other.

It should be noted herein that the main body portion 12 can rotate around a lateral swing axis Ab extending in the height direction of the main body portion 12, as will be described later in detail. Besides, the main body portion 12 can rock around a rising axis Aa extending in the width direction of the traveling body 10. The rotational motion of the main body portion 12 around the lateral swing axis Ab will be referred to hereinafter as “lateral swing”, and the rocking motion of the main body portion 12 around the rising axis Aa will be referred to hereinafter as “vertical swing”.

In the case where the main body portion 12 carries out lateral swing or vertical swing, the longitudinal direction, the width direction, and the height direction of the traveling body 10 as a whole do not coincide with the longitudinal direction, the width direction, and the height direction of the main body portion 12 alone respectively. Thus, in the following description, in the case where a direction with respect to the main body portion 12 is indicated, an explanatory note “of the main body portion 12” will be added as in the case of “the longitudinal direction of the main body portion 12”. In the case where there is no explanatory note “of the main body portion 12”, the direction of the traveling portion 14 as a whole is meant. Incidentally, “the longitudinal direction of the main body portion 12” is a direction in which the ring body 16 penetrates, “the width direction of the main body portion 12” is a direction in which the side members 16S are aligned with each other, and “the height direction of the main body portion 12” is a direction perpendicular to the longitudinal direction and the width direction of the main body portion 12.

As is apparent from FIGS. 1 and 2, the dimension of the main body portion 12 is sufficiently larger in the width direction thereof than in the longitudinal direction thereof. Besides, the dimension of the main body portion 12 in the width direction thereof is equal to or slightly larger than the dimension of the traveling portion 14 in the width direction thereof. On the other hand, the dimension of the main body portion 12 in the longitudinal direction thereof is sufficiently smaller than the dimension of the traveling portion 14 in the width direction thereof.

An article 110 to be conveyed is held inside the ring body 16. In the example shown in the drawings, each of the side members 16S is provided with a plurality of support rails 18, and the box-shaped article 110 is supported from below by the support rails 18. In this case, the article 110 is inserted and removed through an opening portion on a front surface of the ring body 16. Besides, in this case, the article 110 is conveyed while being at least partially exposed to the outside of the ring body 16.

It should be noted herein that it is also conceivable to provide a container or the like for accommodating the entire article 110, instead of the ring body 16. In the case of the container or the like, however, the main body portion 12 increases in size, and tends to increase in weight as well. On the other hand, in the case of the ring body 16 that holds the article 110 with part thereof exposed to the outside, the size and weight of the main body portion 12 can be made smaller and lighter than in the case of the container. Incidentally, as a matter of course, the container or the like may be provided instead of the ring body 16 unless the size or the weight causes a problem.

A side display 48 displaying an image is provided on an outer surface of one of the side members 16S. The side display 48 is configured as, for example, a liquid-crystal display or an organic EL display. On this side display 48, for example, an image showing the current situation (e.g., “during conveyance” or “scheduled to make a right turn”), an image for commercial purposes, or an image for decoration is displayed. By providing the side display 48, it becomes possible to attract the attention of people around the traveling body 10 or make propaganda.

The traveling portion 14 is provided with the front-right wheel 20, the middle-right wheel 22, and the rear-right wheel 24 that are aligned in the longitudinal direction, and the front-left wheel 20, the middle-left wheel 22, and the rear-left wheel 24 that are aligned in the longitudinal direction. The front wheels 20, the middle wheels 22, and the rear wheels 24 are coupled to one another by front links 60 and rear links 62 (which are invisible in FIGS. 1 and 2) that will be described later, respectively. The front links 60 and the rear links 62 are covered with front link covers 28 and rear link covers 30 respectively. By rocking the front links 60 and the rear links 62 relatively to each other respectively around the rising axis Aa, the middle wheels 22 and the main body portion 12 can be lifted upward as shown in FIG. 2, which will be described later. Besides, a center shaft 69, a fixed frame 80, and the like (which are all invisible in FIGS. 1 and 2) are arranged between the middle wheels 22, and are covered with a center cover 32.

Each of the front wheels 20 and the rear wheels 24 is configured as a Mecanum wheel. The Mecanum wheel is a wheel having a plurality of barrel-shaped rollers 26 attached along a circumferential surface of the wheel in such a posture as to be inclined with respect to an axle by 45°. By providing such Mecanum wheels, it becomes possible to move the traveling body 10 in all directions, which will also be described later. Incidentally, each of the middle wheels 22 is configured as a conventional wheel having no roller 26 on a circumferential surface thereof.

It should be noted herein that, as is apparent from FIGS. 1 and 2, the two front link covers 28 are provided apart from each other in the width direction in the present example. Antiskid members 34 are provided on front end surfaces of the front link covers 28 respectively. The antiskid members 34 are made of a material having a higher friction coefficient than the front link covers 28, for example, rubber or high-friction resin. As shown in FIG. 2, when the front link covers 28 (hence the front links 60) are greatly inclined upward in the backward direction and the rear link covers 30 (hence the rear links 62) are greatly inclined upward in the forward direction to lift the main body portion 12, the antiskid members 34 come into contact with a road surface. Then, due to contact of the antiskid members 34 with the road surface, the traveling body 10 can be prevented from moving unintentionally on the road surface. Besides, the antiskid members 34 may be made of a material softer than the front link covers 28. By adopting this configuration, the antiskid members 34 can also function as cushion members for softening the impact caused when the front link covers 28 collide with a person or an object. Besides, the antiskid members 34 are provided only on the front end surfaces of the front link covers 28 respectively in this case, but may be provided on rear end surfaces of the rear link covers 30 respectively instead of or in addition to being provided on the front end surfaces of the front link covers 28 respectively.

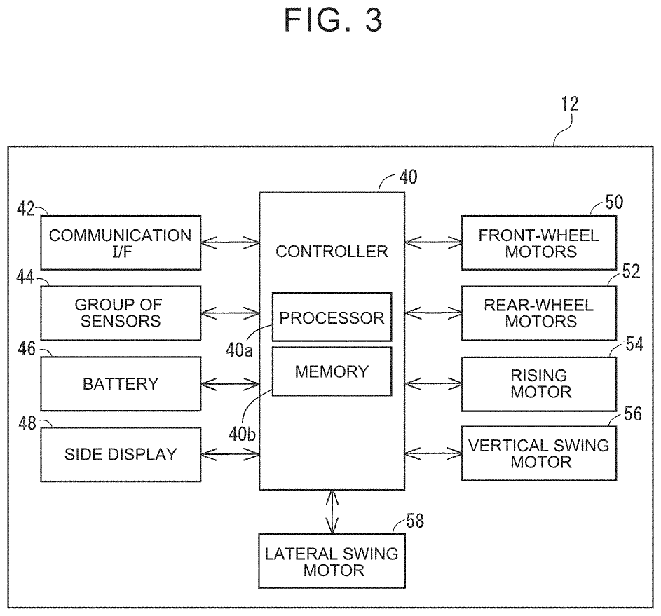

Next, the electric configuration of the traveling body 10 will be described with reference to FIG. 3. The traveling body 10 is provided with a communication interface (which will be abbreviated hereinafter as “a communication I/F”) 42 and a group of sensors 44 to enable autonomous traveling of the traveling body 10. The communication I/F 42 is designed to communicate with external components, and includes pieces of hardware for various kinds of communication such as mobile data communication with the aid of phone lines provided by cell-phone companies and the like, and middle-distance or short-distance wireless communication with the aid of Bluetooth (®) and the like. The external components with which the communication I/F 42 communicates include, for example, a communication terminal installed at some communication center, a cellular communication terminal possessed by an individual, and other traveling bodies. The traveling body 10 may acquire destination information, a road situation, and the like via the communication I/F 42.

The group of sensors 44 includes one or more sensors that detect a traveling state of the traveling body 10 and an environment around the traveling body 10. The group of the sensors 44 includes, for example, at least one of a speed sensor, a camera, a millimeter-wave radar, an infra-red sensor, an LiDAR, an ultrasonic sensor, a GPS sensor, an acceleration sensor, and a gyro sensor. A controller 40 that will be described later drives various motors 50, 52, 54, 56, and 58 based on results detected by the group of the sensors 44 and information acquired via the communication I/F 42.

A battery 46 supplies electric power to various electric components provided on the traveling body 10. The battery 46 may be fixed to the traveling body 10. In this case, the traveling body 10 may have a charger for charging the battery 46, and a charging cable that connects the charger to an external electric power supply. Besides, the battery 46 is removable from the traveling body 10, and may be taken out to the outside of the traveling body 10 and charged if necessary. Alternatively, the battery 46 may be charged in a wireless manner. For example, it is also acceptable to adopt a non-contact charging method in which electric power is supplied through magnetic field resonance of two pairs of coils and capacitors that are incorporated in the traveling body 10 and outside the traveling body 10 respectively.

As described above, the side display 48 is a display that is arranged on a lateral surface of the main body portion 12. The contents displayed on the side display 48 are controlled by the controller 40. Besides, although not shown in FIG. 3, the traveling body 10 may have other output means for providing people around the traveling body 10 with information audibly or visually, for example, a lamp, a speaker, and a buzzer (which are all not shown in the drawing).

The front-wheel motors 50 are motors that rotationally drive the front wheels 20 respectively. The front-wheel motors 50 are provided for the front wheels 20 respectively. Accordingly, the traveling body 10 as a whole is provided with the two front-wheel motors 50. By the same token, a total of the two rear-wheel motors 52, namely, the right rear-wheel motor 52 and the left rear-wheel motor 52 are provided to rotationally drive the rear wheels 24 respectively.

The rising motor 54 is a motor that rocks the front links 60 and the rear links 62 relatively to each other respectively around the rising axis Aa and that hence lifts the main body portion 12 and the middle wheels 22. The vertical swing motor 56 is a motor that rocks the main body portion 12 around the rising axis Aa and that hence swings the main body portion 12 vertically. The lateral swing motor 58 is a motor that rotates the main body portion 12 around the lateral swing axis Ab. The types of the motors 50, 52, 54, 56, and 58 are not limited in particular, as long as a sufficient output can be obtained. Incidentally, the motors 50, 52, 54, 56, and 58 may have brakes capable of locking rotation thereof at the time of non-energization, for example, electromagnetic brakes.

The controller 40 controls the driving of the electric components mounted on the traveling body 10. The controller 40 is a microcomputer having at least a processor 40a and a memory 40b. Respective functions of the controller 40 are realized through the execution of programs stored in the memory 40b by the processor 40a. Incidentally, the processor 40a is a broadly-defined processor, and may be a general-purpose processor (e.g., a central processing unit (CPU)) or a dedicated processor (e.g., a graphics processing unit (GPU), an application specific integrated circuit (ASIC), a field programmable gate array (FPGA), or a programmable logic device). Besides, the processor 40a constituting the controller 40 is not required to be a single physical element, but may be constituted of a plurality of processors located physically apart from one another. By the same token, the memory 40b is also not required to be a single physical element, but may be constituted of a plurality of memories located physically apart from one another. Besides, the memory may include at least one of a semiconductor memory (e.g., a RAM, a ROM, or a solid state drive) and a magnetic disk (e.g., a hard disk drive).

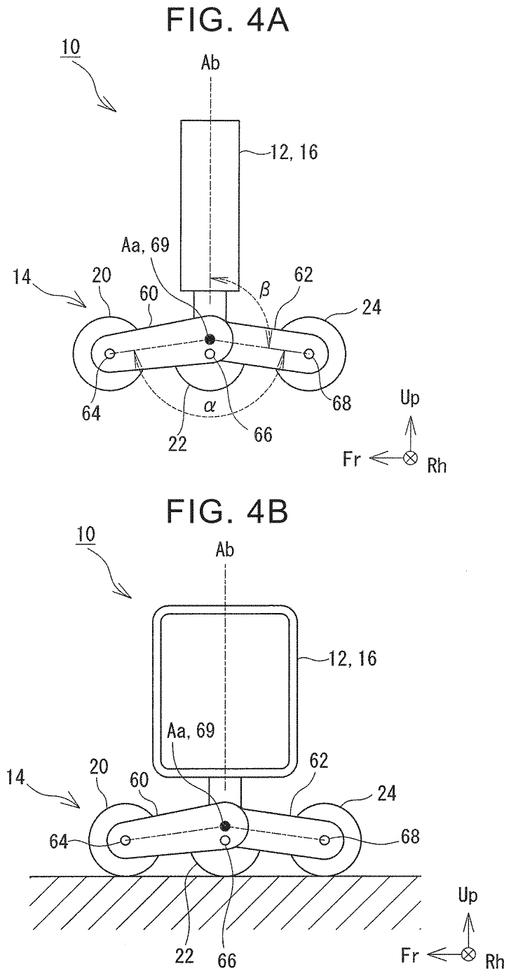

Next, the operation of the traveling body 10 will be described with reference to FIGS. 4A to 6B. FIGS. 4A to 6B are schematic views of the traveling body 10 as viewed sideways. In FIGS. 4A to 6B, the shapes of each of the front links 60 and each of the rear links 62 are shown in a simplified manner. As described above, the front wheels 20, the middle wheels 22, and the rear wheels 24 are coupled to one another via the front links 60 and the rear links 62 respectively. Besides, the center shaft 69 extending along the rising axis Aa exists in the vicinity of the center of the traveling portion 14.

The front links 60 space the rising axis Aa and the front wheels 20 apart from each other respectively by a fixed distance, and rectilinearly couple the center shaft 69 and the front wheels 20 to each other respectively. An axle of the middle wheel 22, namely, a middle axle 66 is fixed to the front links 60. Accordingly, the middle wheels 22 and the rising axis Aa are also spaced apart from each other respectively by a fixed distance.

The rear links 62 space the rising axis Aa and the rear wheels 24 apart from each other respectively by a fixed distance, and rectilinearly couple the center shaft 69 and the rear wheels 24 to each other respectively. The rear links 62 can rock with respect to the front links 60 respectively, around the center shaft 69 (hence the rising axis Aa). The rear links 62 rock with respect to the front links 60 respectively to thereby change an angle α therebetween. The angle formed by each of the front links 60 and each of the rear links 62 will be referred to hereinafter as “a link opening angle α”.

Besides, the main body portion 12 can rock around the rising axis Aa. The main body portion 12 rocks to thereby change an angle β (hereinafter referred to as “a vertical swing angle β”) formed by the main body portion 12 and each of the rear links 62. Furthermore, the main body portion 12 can rotate around the lateral swing axis Ab extending in the height direction thereof. The rotational angle around the lateral swing axis Ab is referred to as “a lateral swing angle”. This lateral swing angle is equal to 0 when the longitudinal direction of the traveling body 10 as a whole and the longitudinal direction of the main body portion 12 coincide with each other, namely, in the state of FIGS. 1 and 2.

As shown in FIG. 4B, the controller 40 rotates the main body portion 12 around the lateral swing axis Ab by 90° such that the lateral surface of the main body portion 12 is directed in the longitudinal direction of the traveling body 10, and that the main body portion 12 penetrates in the width direction of the traveling body 10, in causing the traveling body 10 to travel. This configuration is adopted to alleviate the feeling of pressure when the traveling body 10 travels. That is, the dimension of the main body portion 12 in the width direction thereof is larger than the dimension of the main body portion 12 in the longitudinal direction thereof. Therefore, in the case where the lateral swing angle is equal to 0°, namely, in the case where the front surface of the main body portion 12 having a large horizontal dimension is directed forward with respect to the traveling body 10, the entire traveling body 10 gives the impression of being wide and large when the traveling body 10 is viewed from in front. When the traveling body 10 in this state approaches a user, the user feels a feeling of pressure. On the other hand, in the case where the lateral swing angle is equal to 90°, namely, in the case where the lateral surface of the main body portion 12 having a small horizontal dimension is directed forward with respect to the traveling body 10, the entire traveling body 10 gives the impression of being narrow and small when the traveling body 10 is viewed from in front. In this state, even when the traveling body 10 approaches the user, the feeling of pressure felt by the user can be alleviated.

Besides, by directing the lateral surface of the main body portion 12 in the longitudinal direction of the traveling body 10, the contents displayed on the display 48 provided on the lateral surface of the main body portion 12 is made easily visible by people around the traveling body 10. That is, in the case where the side display 48 is directed in the width direction of the traveling body 10, people have to keep moving together with the traveling body 10 in such a manner as to be present beside the traveling body 10, in order to see the contents displayed on the side display 48. On the other hand, in the case where the side display 48 is directed in the longitudinal direction of the traveling body 10, people can see the contents displayed on the side display 48 and do not have to move at the same speed as the traveling body 10, if present in the longitudinal direction of the traveling body 10. Therefore, when the side display 48 is directed in the longitudinal direction, more people can see the contents displayed on the side display 48 for a longer period of time. The image displayed on the side display 48 is designed to attract the attention of people around the traveling body 10 and make propaganda. By directing the side display 48 in the longitudinal direction, the effect of attracting the attention of people and making propaganda can be enhanced.

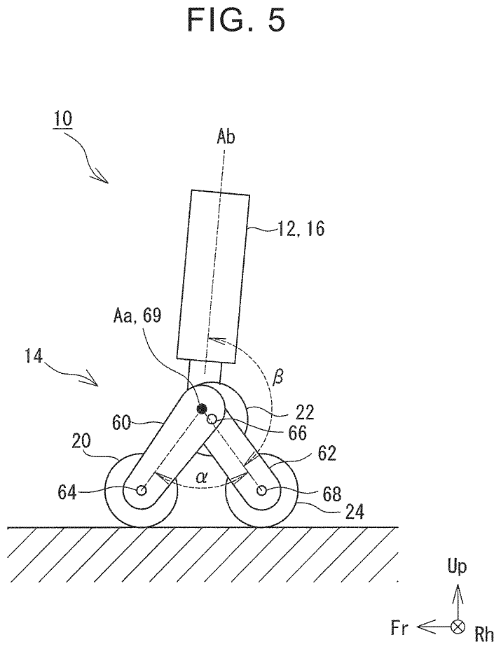

On the other hand, when the traveling body 10 reaches such a position as to face a user at a destination where an article is to be delivered, and hands over the article, the controller 40 returns the lateral swing angle of the main body portion 12 to 0° such that the main body portion 12 penetrates in the longitudinal direction of the traveling body 10, and that the lateral surface of the main body portion 12 is directed in the width direction of the traveling body 10, as shown in FIG. 5. By adopting this configuration, the opening portion on the front surface of the ring body 16 as a slot from which the article is taken out faces the user at the destination where the article is to be delivered. Thus, the user at the destination where the article is to be delivered can take out the article from the main body portion 12 without the need to change the position or direction thereof.

Besides, at this time, the controller 40 may vertically swing the main body portion 12 around the rising axis Aa such that the main body portion 12 is slightly inclined upward in the backward direction, as shown in FIG. 5. In this case, the front surface of the main body portion 12 is directed diagonally upward, and hence toward the vicinity of the head of the user at the destination where the article is to be delivered. This posture of the traveling body 10 is close to a “sitting” posture of a dog or a cat looking up at someone, and hence can make the user at the destination where the article is to be delivered feel a familiarity or an affinity with the traveling body 10.

Besides, in handing over the article, the controller 40 rocks the front links 60 with respect to the rear links 62 respectively to change the link opening angle α, such that the main body portion 12 and the middle wheels 22 are lifted, as shown in FIG. 5. By raising the main body portion 12, the height of the main body portion 12 can be changed such that the article becomes easy to take out.

Incidentally, as a matter of course, when the link opening angle α is changed, the main body portion 12 is greatly inclined unless the vertical swing angle β formed by each of the rear links 62 and the main body portion 12 is also changed. Thus, when the link opening angle α is changed, the controller 40 also rocks the main body portion 12 around the rising axis Aa such that the main body portion 12 is not excessively inclined.

It should be noted herein that the idea of providing a dedicated elevating mechanism instead of changing the link opening angle α is also conceivable to simply change the height of the main body portion 12. For example, it is also conceivable to provide a linear motion mechanism employing a motor and a spline shaft between the traveling portion 14 and the main body portion 12, and elevate and lower the main body portion 12 through the use of this linear motion mechanism. In this case, however, the dedicated mechanism is needed to elevate and lower the main body portion 12, so an increase in weight and a rise in cost are caused.

Besides, in general, people tend to feel a familiarity or an affinity with an animal, especially something similar to a dog or a cat as a pet. Moreover, any quadrupedal animal such as a dog or a cat often changes the posture of its legs in significantly changing the height of its trunk or head. For example, a dog or a cat that is in a “lying” posture with its forelegs and hind legs on the ground and with its head at a low position assumes the “sitting” posture with its head out of contact with the ground, by raising its forelegs. The motion of changing only the height of the main body portion 12 through the use of the linear motion mechanism without changing the posture of the traveling portion 14 is greatly different from the motion of such a quadrupedal animal, so the user is unlikely to feel an affinity with the traveling body 10.

On the other hand, the motion of lifting the middle wheels 22 and the main body portion 12 by rocking the rear links 62 with respect to the front links 60 respectively as in the present example is close to the motion of a quadrupedal animal, especially the motion of a dog or a cat assuming the “sitting” posture from the “lying” posture, so the user tends to feel an affinity with the traveling body 10.

Incidentally, this effect can be further enhanced by providing the two front link covers 28 covering the front-right and front-left links 60 respectively apart from each other in the width direction. That is, the presence of the two front link covers 28 in a spaced-apart relation in the width direction makes it easy to associate the front link covers 28 with “the forelegs” of a quadrupedal animal. Furthermore, in the present example, the rear link covers 30 covering the rear links 62 respectively substantially assume a “T” shape in a plan view, that is, such a shape as to spread in both right and left directions after extending backward from front ends thereof. In the case where the rear link covers 30 are in this shape, when the traveling body 10 is viewed from behind, the rear link covers 30 are likely to conjure the image of “the hip” of a dog or a cat. Moreover, for this reason, the user tends to feel the traveling body 10 as something close to a quadrupedal animal, and feels more affinity with the traveling body 10.

Besides, the main body portion 12 may thus be lifted not only when the article is handed over, but also when the traveling body 10 is stored in a specific space. In storing the traveling body 10, when the link opening angle α is changed to lift the main body portion 12, the dimension of the traveling body 10 in the longitudinal direction can be reduced, and the required space for storage can be reduced.

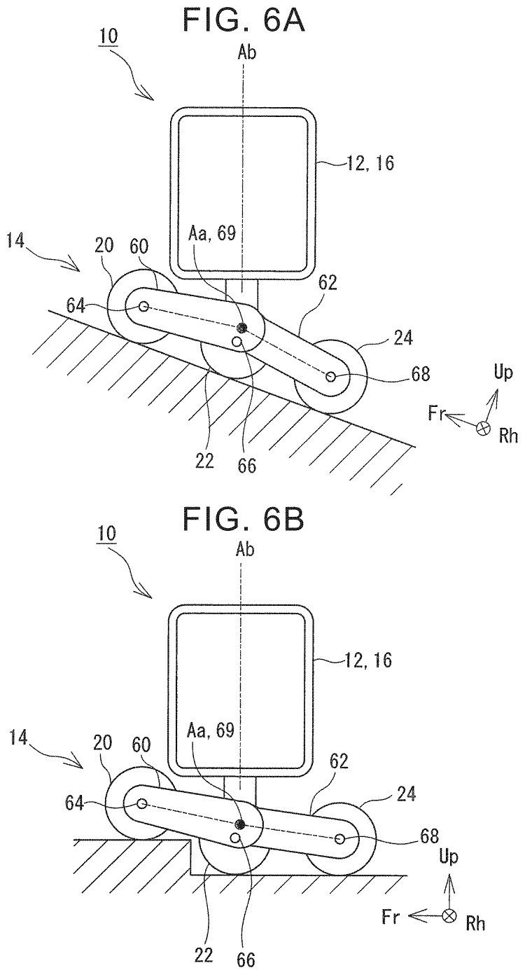

Besides, the main body portion 12 may be vertically swung not only when being lifted but also in various situations. For example, a case where the traveling body 10 travels on a slope as shown in FIG. 6A is considered. In this case, in order to keep the main body portion 12 horizontal, the vertical swing angle β needs to be changed by rocking the main body portion 12 with respect to the rear links 62. Thus, when the traveling body 10 travels on the slope, the controller 40 may drive the vertical swing motor 56 to keep the main body portion 12 horizontal.

Besides, a message may be conveyed from the traveling body 10 to people around the traveling body 10 through the use of vertical swing or lateral swing of the main body portion 12. For example, when the traveling body 10 stops in front of the user at the destination where the article is to be delivered, the controller 40 may vertically swing the main body portion 12 such that the main body portion 12 is temporarily inclined upward in the forward direction. In this case, the traveling body 10 can strike the user at the destination where the article is to be delivered, as “bowing” or “nodding”. Besides, when the user behaves undesirably, the controller 40 may laterally swing the main body portion 12 in a laterally reciprocating manner. In this case, the traveling body 10 can strike the user as “shaking one's head”, and can make the user grasp the inappropriateness of his or her behavior. Moreover, by conveying a message to people through the motion of the traveling body 10 in this manner, the traveling body 10 tends to strike the user as being close to a creature, so the user feels more affinity with the traveling body 10.

Furthermore, as described hitherto, the traveling body 10 is mounted with the sensors such as a camera and the like. By providing the main body portion 12 with these sensors and rocking and laterally swinging the main body portion 12 if necessary, the detecting directions of the sensors can be changed. For example, when the camera is provided on the lateral surface of the ring body 16, the direction in which the camera captures images can be changed by rotating the main body portion 12 around the lateral swing axis Ab.

Besides, the traveling body 10 has the three right wheels and the three left wheels that are each coupled to one another by the links respectively, and hence can stably travel over a bump and on a slope as well. For example, as shown in FIG. 6B, even when the front wheels 20 are lifted to travel over a bump, the remaining wheels, namely, the middle wheels 22 and the rear wheels 24 (i.e., four wheels of the traveling body 10 as a whole) can stay in contact with the road surface. Therefore, the center of gravity of the traveling body 10 is stabilized, and the traveling body 10 can be effectively prevented from tipping over or swaying.

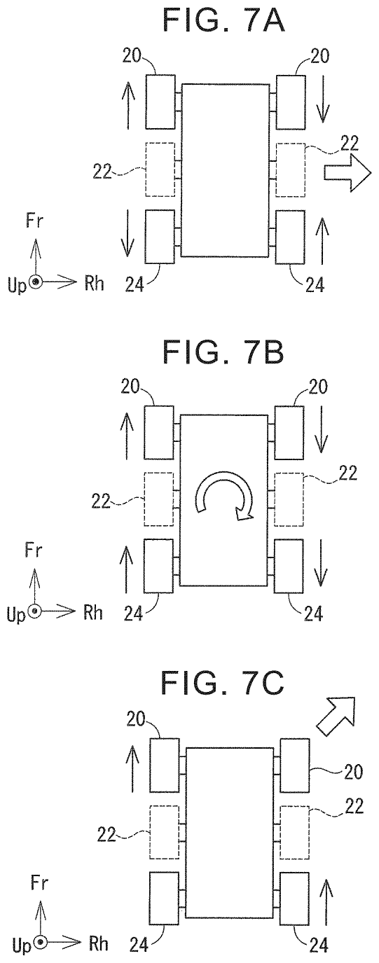

By the way, in the present example, the middle wheels 22 can be lifted by changing the link opening angle α. By adopting this configuration, the traveling body 10 can be moved in all directions. This will be described with reference to FIGS. 7A to 7C. FIGS. 7A to 7C are schematic views of the traveling body 10 as viewed from above. In FIGS. 7A to 7C, blank arrows indicate the direction of travel of the traveling body 10, and arrows beside the wheels indicate the rotating directions of the respective wheels. That is, the upward arrows beside the wheels on the sheet indicate rotation of the wheels moving forward, and the downward arrows beside the wheels on the sheet indicate rotation of the wheels moving backward. Rotation of the wheels moving forward will be referred to hereinafter as “forward rotation”, and rotation of the wheels moving backward will be referred to hereinafter as “backward rotation”.

In the case where a Mecanum wheel having the rollers 26 on the circumferential surface thereof is used, this movement in all directions is made possible. It should be noted, however, that the middle wheels 22 are conventional wheels having no rollers 26 and cannot move in the lateral direction in the present example. Therefore, in moving the traveling body 10 in all directions, the controller 40 changes the link opening angle α to lift the middle wheels 22, and keeps only the front wheels 20 and the rear wheels 24 as Mecanum wheels in contact with the ground. In FIGS. 7A to 7C, the middle wheels 22 that are out of contact with the ground are indicated by broken lines.

In this state, a case where the front wheels 20 and the rear wheels 24 are rotated such that the wheels adjacent to each other in the longitudinal direction are rotated in opposite directions and that the wheels adjacent to each other in the lateral direction are rotated in opposite directions as shown in FIG. 7A is considered. That is, a case where the front wheel 20 on one of the right and left sides (on the left side in the example shown in the drawing) is rotated forward, the rear wheel 24 on this side is rotated backward, the front wheel 20 on the other of the right and left sides (on the right side in the example shown in the drawing) is rotated backward, and the rear wheel 24 on this side is rotated forward is considered. In this case, the traveling body 10 laterally moves toward one of the right and left sides (toward the right side in the example shown in the drawing) without changing the direction of the traveling body 10 itself.

Besides, a case where the front wheels 20 and the rear wheels 24 are rotated such that the wheels adjacent to each other in the longitudinal direction are rotated in the same direction and that the wheels adjacent to each other in the lateral direction are rotated in opposite directions as shown in FIG. 7B is considered. That is, a case where the front wheel 20 and the rear wheel 24 on one of the right and left sides (on the right side in the example shown in the drawing) are rotated backward, and the front wheel 20 and the rear wheel 24 on the other of the right and left sides (on the left side in the example shown in the drawing) are rotated forward is considered. In this case, the traveling body 10 can turn without moving anywhere.

Furthermore, when the front wheel 20 on one of the right and left sides is rotated forward, the rear wheel 24 on the other of the right and left sides is rotated forward, and the other front wheel 20 and the other rear wheel 24 are not rotated as shown in FIG. 7C, the traveling body 10 can be moved diagonally, namely, forward and toward one of the right and left sides.

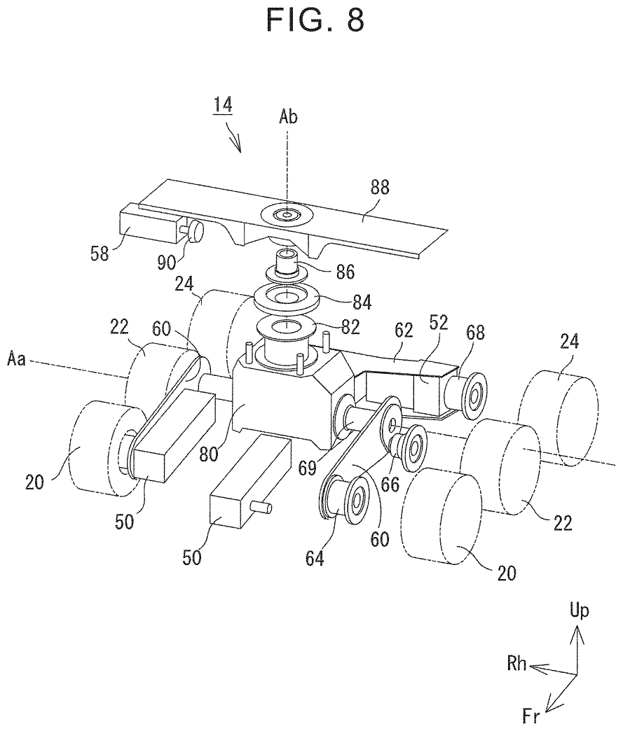

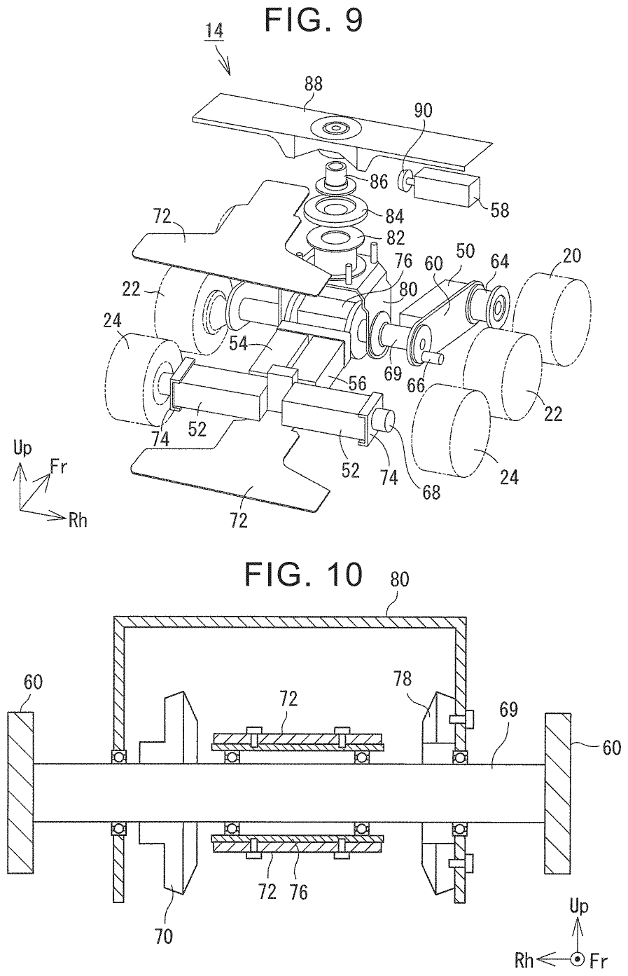

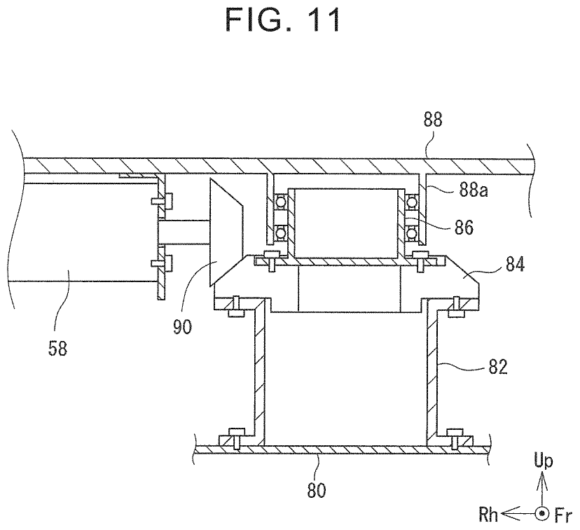

Next, the mechanical configuration of the traveling portion 14 of the traveling body 10 will be described with reference to FIGS. 8 to 11. FIGS. 8 and 9 are partially exploded perspective views of the traveling body 10 with the covers thereof removed. FIG. 8 is a view of the traveling body 10 as viewed from diagonally in front, and FIG. 9 is a view of the traveling body 10 as viewed from diagonally behind. Besides, FIG. 10 is a longitudinal cross-sectional view of the traveling portion 14 around the center shaft 69, and FIG. 11 is a longitudinal cross-sectional view of the traveling portion 14 around a coupling shaft 86.

The substantially box-shaped fixed frame 80 having an open rear end surface and an open bottom surface is provided in a central region of the traveling portion 14. Besides, the center shaft 69 is provided in such a manner as to cross the fixed frame 80 in the width direction. The center shaft 69 is provided such that the location and direction thereof coincide with those of the rising axis Aa.

The front links 60 are securely fixed to both ends of the center shaft 69 in the width direction, respectively. As described above, the front links 60 space the front wheels 20 and the rising axis Aa apart from each other respectively by a fixed distance, and couple the front wheels 20 and the center shaft 69 to each other respectively. The shape of the front links 60 is not limited in particular. In the present example, however, each of the front links 60 is a plate member arranged such that the thickness direction thereof extends parallel to the width direction of the traveling body 10. The middle axle 66 as an axle of the middle wheels 22 is attached to the front links 60 in the vicinity of rear ends thereof, and a front axle 64 as an axle of the front wheels 20 is attached to the front links 60 in the vicinity of the front ends thereof. Accordingly, the positional relationship among the center shaft 69, the front wheels 20, and the middle wheels 22 is fixed by the front links 60. The front links 60 are further provided with the front-wheel motors 50 for rotationally driving the front wheels 20 respectively. Each of the two front-wheel motors 50 is provided for one of the front wheels 20.

Besides, as shown in FIG. 9, a coupling frame 76 is attached to a central region of the center shaft 69 in the axial direction, rotatably with respect to the center shaft 69. A pair of rear link plates 72 are attached to an upper surface and a bottom surface of the coupling frame 76 respectively. Each of the rear link plates 72 is a plate member that substantially assumes a “T” shape in a plan view, that is, such a shape as to spread in both right and left directions after extending backward from a front end thereof. The rear-wheel motors 52, the rising motor 54, and the vertical swing motor 56 are arranged and fixed between the rear link plates 72. The rear-wheel motors 52 are motors that rotationally drive the rear wheels 24 respectively. Each of the two rear-wheel motors 52 is provided for one of the rear wheels 24. Coupling brackets 74 are attached to outer end portions of the rear-wheel motors 52 in the width direction respectively. A rear axle 68 as an axle of the rear wheels 24 is attached to the coupling brackets 74. Besides, the rear link plates 72 are fastened to upper surfaces and bottom surfaces of the coupling brackets 74 respectively by bolts or the like. Accordingly, the coupling frame 76, the rear link plates 72, and the coupling brackets 74 space the center shaft 69 (hence the rising axis Aa) and the rear wheels 24 apart from each other respectively by a fixed distance, and function as the rear links 62 for coupling the center shaft 69 and the rear wheels 24 to each other respectively.

The rising motor 54 is a motor that lifts the main body portion 12 and the middle wheels 22 by rocking the front links 60 with respect to the rear links 62 respectively. Besides, the vertical swing motor 56 is a motor that rocks the fixed frame 80 and hence the main body portion 12 coupled to the fixed frame 80 with respect to the rear links 62 around the rising axis Aa. The mechanical coupling of these motors and the respective members will be described with reference to FIG. 10.

As shown in FIG. 10, the coupling frame 76 is rotatably attached to the center of the center shaft 69 via a bearing. The rear link plates 72 are fastened to an upper surface and a bottom surface of the coupling frame 76. The rising motor 54 and the vertical swing motor 56 (which are invisible in FIG. 10) are fastened to the rear link plates 72.

Furthermore, a rising gear 70 as a bevel gear is also securely fixed to the center shaft 69. The rising gear 70 is securely coupled to the center shaft 69, and rotates together with the center shaft 69. Besides, the rising gear 70 is concentric with the center shaft 69 (hence the rising axis Aa). A bevel gear (not shown) meshing with the rising gear 70 is attached to an output shaft of the rising motor 54. The rising gear 70 and the bevel gear meshing therewith function as a transmission mechanism that transmits the motive power output by the rising motor 54 to the front links 60 without the intermediary of the wheels. Incidentally, as a matter of course, another transmission mechanism may be provided instead of or in addition to the rising gear 70 and the bevel gear, as long as the motive power output by the rising motor 54 attached to one of the links can be transmitted to the other link without the intermediary of the wheels. For example, another type of gear, pulley, or the like may be provided.

The rising motor 54 is fastened to the rear link plates 72. Therefore, as the rising motor 54 rotates, the rising gear 70, the center shaft 69, and the front links 60 rock with respect to the rear links 62 respectively around the rising axis Aa. Then, the link opening angle α formed by each of the front links 60 and each of the rear links 62 is thus changed, and the middle wheels 22 and the main body portion 12 rise/fall.

The fixed frame 80 to which the main body portion 12 is coupled is rotatably attached to the center shaft 69 via a bearing. A vertical swing gear 78 as a bevel gear is securely fixed to a lateral surface of the fixed frame 80. The vertical swing gear 78 is concentric with the center shaft 69 (hence the rising axis Aa). A bevel gear (not shown) meshing with the vertical swing gear 78 is attached to an output shaft of the vertical swing motor 56. Furthermore, the vertical swing motor 56 is fastened to the rear link plates 72. Therefore, as the vertical swing motor 56 rotates, the vertical swing gear 78, the fixed frame 80, and the main body portion 12 rock with respect to the rear links 62 around the rising axis Aa.

Next, a mechanism that rotates the main body portion 12 around the lateral swing axis Ab will be described. As shown in FIGS. 8 and 9, the traveling portion 14 is provided with a support frame 88. The support frame 88 is a member that is securely fixed to a bottom surface of the ring body 16 (not shown in FIGS. 8 and 9) constituting the main body portion 12. The support frame 88 is coupled to the fixed frame 80 via a fixed shaft 82, a lateral swing gear 84, and the coupling shaft 86.

That is, as shown in FIG. 11, the fixed shaft 82 is fastened to an upper surface of the fixed frame 80, and the lateral swing gear 84 as a bevel gear is fastened to an upper surface of the fixed shaft 82. Furthermore, the coupling shaft 86 is fastened to an upper surface of the lateral swing gear 84. The fixed shaft 82, the lateral swing gear 84, and the coupling shaft 86 are concentric with the lateral swing axis Ab. A cylindrical coupling rib 88a protrudes from a bottom surface of the support frame 88. The coupling rib 88a is rotatably coupled to the coupling shaft 86 via a bearing.

Furthermore, the lateral swing motor 58 is attached to the bottom surface of the support frame 88. The lateral swing motor 58 is a motor that rotates the main body portion 12 around the lateral swing axis Ab. A bevel gear 90 meshing with the lateral swing gear 84 is attached to an output shaft of the lateral swing motor 58. In this case, as the lateral swing motor 58 rotates, the support frame 88 and the main body portion 12 rotate around the lateral swing axis Ab.

The middle wheels 22 and the main body portion 12 are lifted, for example, according to the following procedure. The controller 40 first locks the front-wheel motors 50 to keep the front wheels 20 from rotating. In this state, the controller 40 rotates the rising motor 54 to rock the front links 60 with respect to the rear links 62 respectively around the rising axis Aa. Thus, the link opening angle α is reduced, and the middle wheels 22 and the main body portion 12 are lifted. The controller 40 may rotate the rear-wheel motors 52 forward in coordination with rotation of the rising motor 54. Thus, the middle wheels 22 and the main body portion 12 rise more smoothly. It should be noted herein that when the vertical swing angle β is constant in the case where the inclination of the rear links 62 significantly changes as the middle wheels 22 and the like rise, the main body portion 12 is greatly inclined. Therefore, in rotating the rising motor 54, the controller 40 also rotates the vertical swing motor 56 in coordination with rotation of the rising motor 54 such that the main body portion 12 is not excessively inclined.

It should be noted, however, that the procedure of rising described herein is an example and may be appropriately changed as long as at least the middle wheels 22 and the main body portion 12 can be lifted. For instance, in the present example, a dedicated motor, namely, the rising motor 54 is provided to lift the middle wheels 22 and the main body portion 12. However, the middle wheels 22 and the main body portion 12 may be lifted with the aid of rotation of the front wheels 20 and the rear wheels 24, without providing the rising motor 54. That is, when the two front wheels 20 of the traveling body 10 are rotated backward and the two rear wheels 24 of the traveling body 10 are rotated forward to make the front wheels 20 and the rear wheels 24 approach each other respectively, the middle wheels 22 and the main body portion 12 can be lifted even without the rising motor 54. In this case, however, the control of rotating the wheels and the control of lifting the middle wheels 22 are performed in coordination with each other, so the overall control tends to be complicated. In the case where the rising motor 54 is provided and the motive power output by the rising motor 54 is transmitted to the front links 60 or the rear links 62 via the rising gear 70 without the intermediary of the wheels as in the present example, the control of rotating the wheels and the act of lifting the middle wheels 22 and the like can be controlled independently of each other, so the control of the traveling body 10 can be simplified.

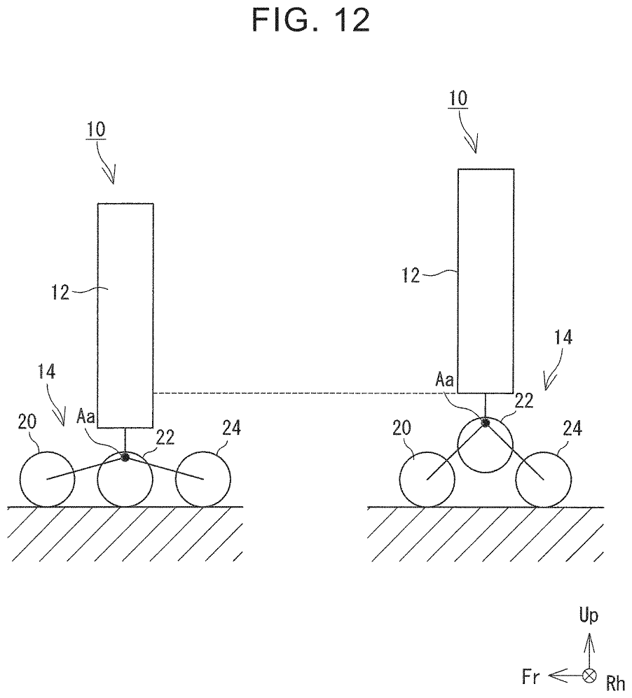

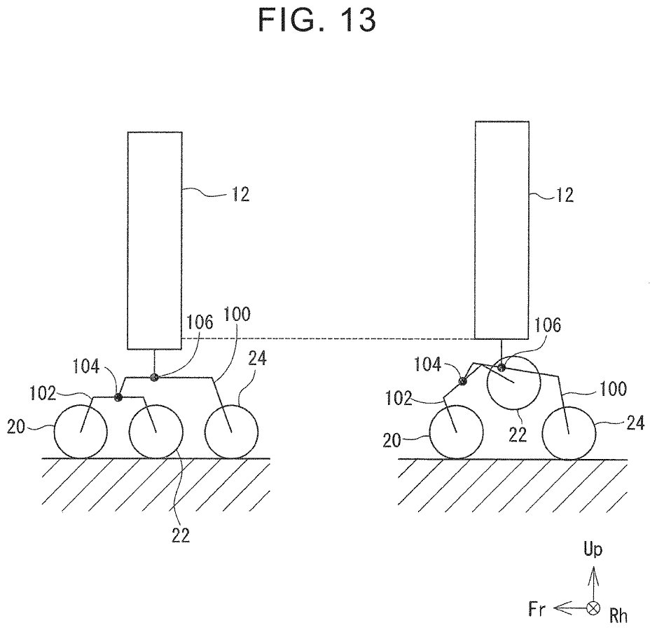

Next, the difference between the mechanism of the traveling portion 14 disclosed in the present application and a rocker bogie mechanism will be described. FIG. 12 is a schematic view of the traveling body 10 disclosed in the present specification, and FIG. 13 is a schematic view of a traveling body mounted with the rocker bogie mechanism. As is the case with the traveling portion 14 of the present application, the rocker bogie mechanism has three right wheels and three left wheels that are coupled to each other by links respectively. It should be noted, however, that there are two separate rocking axes, namely, two separate joints for the links in the case of the rocker bogie mechanism. That is, in the case of the rocker bogie mechanism, the front wheels 20 and the middle wheels 22 are coupled to each other by bogie links 102 respectively as shown in FIG. 13. Besides, the bogie links 102 and the rear wheels 24 are coupled to each other by rocker links 100 extending above the bogie links 102, respectively. The bogie links 102 rock around a first axis 104 as a coupling location of the bogie links 102 and the rocker links 100, and the rocker links 100 rock around a second axis 106 as a coupling location of the rocker links 100 and the main body portion 12. That is, the rocker bogie mechanism has the two joints as axes of rotation of the links that are spaced apart from each other in the vertical direction and in the longitudinal direction.

On the other hand, in the case of the traveling portion 14 disclosed in the present application, the front links 60 and the rear links 62 rock around the single rising axis Aa, as is apparent from the foregoing description. Accordingly, there is a single joint as an axis of rotation of the links. The presence of the single joint makes it easier to compute the postures of the respective links than in the case where there are two separate joints.

Besides, in the rocker bogie mechanism, the rocker links 100 and the bogie links 102 overlap with each other respectively in the vertical direction, so the center of gravity of the rocker bogie mechanism tends to be high. As a result, the center of gravity of the traveling body as a whole is high, and the posture of the traveling body 10 is unlikely to be stabilized.

Besides, even in the rocker bogie mechanism, the main body portion 12 can be raised by rocking the rocker links 100 and the bogie links 102 as shown in FIG. 13. However, the rocker bogie mechanism has the two links that overlap with each other in the vertical direction on each side, so the lift amount of the main body portion 12 tends to be small even when an attempt is made to lift the main body portion 12 by rocking the rocker links 100 and the bogie links 102. That is, as is apparent from a comparison between FIG. 12 and FIG. 13, the traveling portion 14 having the single joint as disclosed in the present application can raise the main body portion 12 higher than the rocker bogie mechanism.

As is apparent from the foregoing description, the traveling body 10 disclosed in the present specification can stably travel over a bump and on a slope as well, so high ability to overcome obstacles while traveling is obtained. Besides, the main body portion 12 can be raised high by rocking the front links 60 and the rear links 62. This is closer to the motion of a quadrupedal animal such as a dog or a cat that straightens up, than in the case where only the main body portion 12 is raised independently of the traveling portion 14. As a result, people tend to feel an affinity with the traveling body 10 disclosed in the present specification. Incidentally, the configuration described hitherto is an example. Other configurational details may be changed as long as the front links 60 that space the rising axis Aa and the front wheels 20 apart from each other respectively by a fixed distance and the rear links 62 that space the rising axis Aa and the rear wheels 24 apart from each other respectively by a fixed distance are coupled to each other respectively in such a manner to be able to rock with respect to each other around the rising axis Aa respectively.

For example, the main body portion 12 may not be able to swing vertically or laterally. Besides, in the specification of the present application, the middle wheels 22 are attached to the front links 60 respectively. However, the middle wheels 22 may be attached to the rear links 62 or other members respectively as long as the distance between the middle wheels 22 and the rising axis Aa is fixed.

Besides, in the present specification, the traveling body 10 holding the article inside the rectangular ring has been described as an example, but the shape of the main body portion 12 may be appropriately changed. For example, the container-shaped main body portion 12 may be provided instead of the rectangular ring-shaped main body portion 12. Besides, the traveling body 10 may be used for purposes other than the conveyance of articles. Besides, in the present specification, the traveling body 10 can travel autonomously. However, the traveling body 10 may be piloted remotely.

What is claimed is:

1. A traveling body comprising:
a main body portion; and
a traveling portion provided on a lower side of the main body portion, wherein
the traveling portion has a pair of middle wheels, namely, a middle-right wheel and a middle-left wheel that are spaced apart from a rising axis extending in a width direction by a fixed distance, a pair of front wheels that are arranged in front of the middle wheels respectively, a pair of rear wheels that are arranged behind the middle wheels respectively, front links that space the front wheels and the rising axis apart from each other respectively by a fixed distance, rear links that space the rear wheels and the rising axis apart from each other respectively by a fixed distance, a fixed frame that rises/falls as the rising axis rises/falls, and that supports the main body portion, and a controller,
the front links and the rear links are coupled in such a manner as to be able to rock with respect to each other respectively around the rising axis, and
the controller lifts the main body portion and the middle wheels by rocking the front links and the rear links with respect to each other respectively.

2. The traveling body according to claim 1, wherein
the traveling portion further has a rising motor, and a transmission mechanism that transmits a motive power output by the rising motor to the front links or the rear links, as a rocking motion around the rising axis, without intermediary of the wheels.

3. The traveling body according to claim 2, wherein
the traveling portion further has front-wheel motors that rotate the front wheels respectively, and rear-wheel motors that rotate the rear wheels respectively, and
the rising motor, the front-wheel motors, and the rear-wheel motors are able to be driven independently of one another.

4. The traveling body according to of claim 1, wherein
the traveling portion further has a vertical swing motor that rocks the main body portion around the rising axis.

5. The traveling body according to claim 1, wherein
the traveling portion further has a lateral swing motor that rotates the main body portion around a lateral swing axis extending in a height direction of the main body portion.

6. The traveling body according to claim 1, wherein
each of the front wheels and the rear wheels is a Mecanum wheel having a barrel-shaped roller arranged on a circumferential surface of the wheel, and
the controller moves the traveling body in all directions by rotationally driving the front wheels and the rear wheels, with the middle wheels lifted.

7. The traveling body according to claim 1, wherein
the traveling portion further has front link covers that cover the front links respectively, rear link covers that cover the rear links respectively, and antiskid members that are provided on at least either front end surfaces of the front link covers or rear end surfaces of the rear link covers respectively.
